(19) United States
(12) Patent Application Publication
(10) Pub. No.: US 2026/0080523 A1
(43) Pub. Date: Mar. 19, 2026

(54) GENERATING COMBINED CONFIDENCE METRICS FOR COMPLEX SYSTEMS

(71) Applicant: Fyusion, Inc., San Francisco, CA (US)

(72) Inventors: Matteo Munaro, San Francisco, CA (US); Sabato Ceruso, Puerto Santiago (ES); Pavel Hanchar, Minsk (BY); Jan Botsch, Berlin (DE)

(73) Assignee: Fyusion, Inc., San Francisco, CA (US)

(21) Appl. No.: 19/043,023

(22) Filed: Jan. 31, 2025

Related U.S. Application Data
(60) Provisional application No. 63/694,519, filed on Sep. 13, 2024.

(51) Int. Cl. G06T 7/00; G06V 20/10; G06V 20/68

(52) U.S. Cl. CPC G06T 7/0002; G06V 20/188; G06V 20/68; G06T 2207/30128

(57) ABSTRACT

A computing system configured to process a plurality of intermediate outputs from machine learning models to generate final outputs may be maintained. A combined confidence metric that reflects a probability that the final outputs are accurate may be determined based on the intermediate outputs. Outputs associated with combined confidence metrics that are below the threshold may be caused to be discarded.

### CROSS-REFERENCE TO RELATED APPLICATIONS

This application this application is entitled to and claims the benefit of the filing date of U.S. Provisional App No. 63/694,519 by Munaro et al., titled INVOLVING MULTIPLE INTERMEDIATE OUTPUTS, filed on Sep. 13, 2024 (Attorney Docket No. FYSNP086P), which is hereby incorporated by reference in its entirety and for all purposes.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

The present disclosure relates generally to complex computational models, and more specifically to generating combined confidence metrics for complex systems.

### BACKGROUND

While individual predictions associated with components of complex systems often have well-defined confidence metrics, it may be extremely difficult to estimate confidence intervals for aggregated predictions from such systems.

### BRIEF DESCRIPTION OF DRAWINGS

The included drawings are for illustrative purposes and serve only to provide examples of possible structures and operations for the disclosed inventive systems, apparatus, methods, and computer program products for confidence metric generation. These drawings in no way limit any changes in form and detail that may be made by one skilled in the art without departing from the spirit and scope of the disclosed implementations.

FIG. 1 illustrates a method for generating combined confidence metrics, performed in accordance with some implementations.

FIG. 2 illustrates an example of a block diagram of a combined confidence metric generation model, in accordance with some implementations.

FIG. 3 illustrates an example of a graph showing the variation in false positive rejection rates and true positive rejection rates versus confidence metric threshold, in accordance with some implementations.

FIG. 4 illustrates an example of a greenhouse, in accordance with some implementations.

FIG. 5 illustrates a particular example of a computer system configured in accordance with some implementations.

### DETAILED DESCRIPTION

The various embodiments, techniques and mechanisms described herein provide for generating combined confidence metrics for complex systems involving multiple intermediate outputs. As discussed herein, the term “confidence metric” of an estimate or prediction generally refers to a probability that the estimate or prediction is correct. A confidence metric may be a machine learning classifier usable to assess the probability of correctness of a variety of predictions. Such complex systems may include any type of pipeline where multiple intermediate outputs, internal results, other data, and/or prior information are used to make a prediction or estimate. By way of example, such complex systems may include advanced image analysis and defect detection systems used in agriculture, advanced image analysis and defect detection systems of structures and/or vehicles, etc.

In the context of agriculture, advanced image analysis and defect detection systems may take crop and soil data and imaged or multi-view captures of crops as input, applying a multi-stage process involving image processing, feature extraction, metadata integration, 3D model reconstruction, defect detection and classification etc. Such a model may employ computer vision algorithms, Convolutional Neural Networks (CNNs) or other deep learning architectures at a variety of these stages. The outputs of such neural networks are referred to herein as “intermediate outputs” as these intermediate outputs are used as inputs for other models. Such advanced image analysis and defect detection systems, and components and processes involved in such advanced image analysis and defect detection systems are outlined in U.S. Patent Application Ser. No. 18/962,476 by Munaro, et al, which is incorporated by reference herein in its entirety and for all purposes.

While many examples discussed herein relate to advanced image analysis and defect detection systems related to agricultural monitoring, the disclosed techniques are widely applicable to any type of complex system that uses such intermediate outputs.

Traditionally, complex pipelines (e.g., agricultural monitoring systems using advanced image analysis) give users little information about the correctness of their final outputs. Confidence metrics are commonly used for singular neural networks. However, existing techniques are not usable to quantify the probability of correctness for pipelines composed of many steps or multiple features (e.g., location, type, and/or severity of crop defects.) By way of example, Capulet Farming uses a traditional agricultural monitoring pipeline to estimate locations where their crops are not receiving sufficient water. Unfortunately, their pipeline generates a high number of false positives, giving the impression that the crops require more water than is actually needed. As such, Capulet Farming wastes water irrigating crops unnecessarily and, worse, overwaters their crop, resulting in a lower yield.

In contrast to conventional approaches, the disclosed techniques may be used to automatically generate confidence metrics for complex systems (e.g., the advanced image analysis and defect detection systems discussed above). The disclosed techniques provide improved mechanisms for enhancing image and defect detection capabilities to overcome traditional challenges, such as reduced accuracy, increased labor costs, and diminished crop yields. As a result, the disclosed techniques can contribute to more efficient, productive, and sustainable agricultural practices. By way of illustration, returning to the example of the previous paragraph, Capulet Farming applies the disclosed techniques to their agricultural monitoring pipeline to create combined confidence metrics that give a probability of correctness to the final estimations of locations where crops need water generated by their pipeline. As a result, they can reject predictions with a combined confidence metric below a chosen threshold (e.g., 0.35). Furthermore, Capulet Farming can apply these combined confidence metrics to other estimates generated by their agricultural monitoring pipeline such as defect detection predictions. As such, the organization wastes less water and increases crop yield.

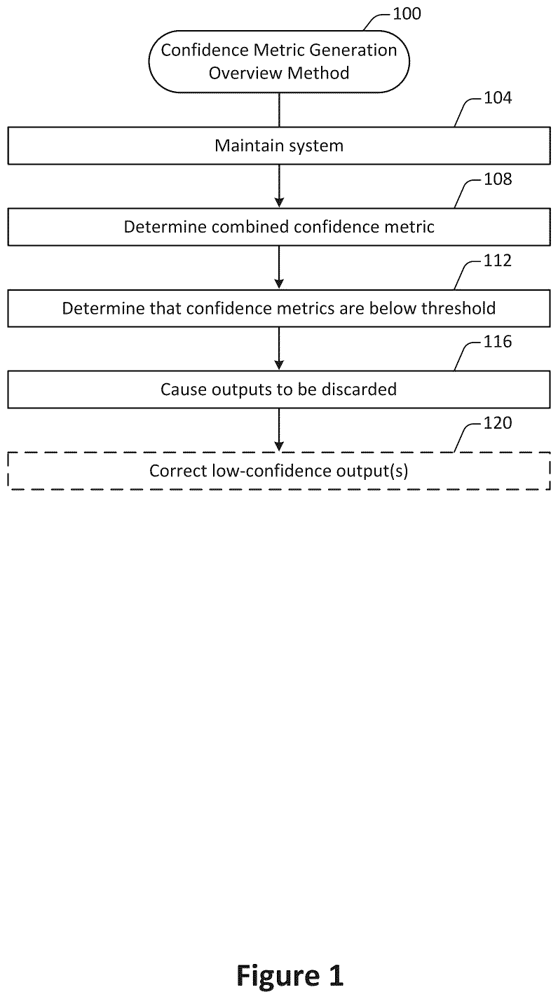

Referring now to the Figures, FIG. 1 illustrates a method for generating combined confidence metrics, performed in accordance with some implementations.

At 104 of FIG. 1, a computing system is maintained. The computing system may be configured to process a plurality of intermediate outputs from machine learning models, and a variety of other data, to generate final outputs. By way of example, the intermediate outputs may include predictions or estimate from neural networks or other deep learning architectures. The intermediate outputs may each have corresponding confidence metrics. The computing system may have a variety of additional inputs such as internal results, other data and/or prior information that may be useful in making a prediction or estimate. The computing system may produce final outputs as predictions or estimates of a variety of entities, objects, attributes, events, occurrences, etc. As discussed below, while many examples discussed herein involve making predictions or estimates related to defect detection and/or advanced image analysis of crops, the disclosed techniques are not limited to such examples.

In the context of defect detection and/or advanced image analysis of crops, the computing system may receive a set of images of a crop. The images may be captured in a variety of manners from any type of camera. The images may include any combination of multi-view or single view captures of objects such as crops.

The computing system may take crop and soil data and multi-view capture(s) of a crop, and other data as input. The computing system may execute an advanced image analysis and defect detection pipeline (e.g., a multi-stage process involving image processing, feature extraction, 3D model reconstruction, metadata integration, defect detection and classification, etc.) In executing such a multi-stage process, the computing system may employ computer vision algorithms, Convolutional Neural Networks (CNNs) or other deep learning architectures at a variety of these stages. As discussed above the outputs of such deep learning architectures are referred to herein as intermediate outputs because they form inputs for other model(s). One having skill in the art may appreciate that complex pipelines may be executed in a variety of ways. As discussed above, some examples of advanced image analysis and defect detection systems, and components and processes involved in such advanced image analysis and defect detection systems some examples are given in further detail in in U.S. Patent Application Ser. No. 18/962,476 by Munaro, et al.

Returning to FIG. 1, at 108, a combined confidence metric may be determined. As discussed above, the combined confidence metric may reflect a probability that the final outputs of a multi-stage process (e.g., a defect detection pipeline) are accurate. The combined confidence metric may be determined based on the intermediate outputs. In other words, the intermediate outputs may serve as inputs for the confidence metric estimate model.

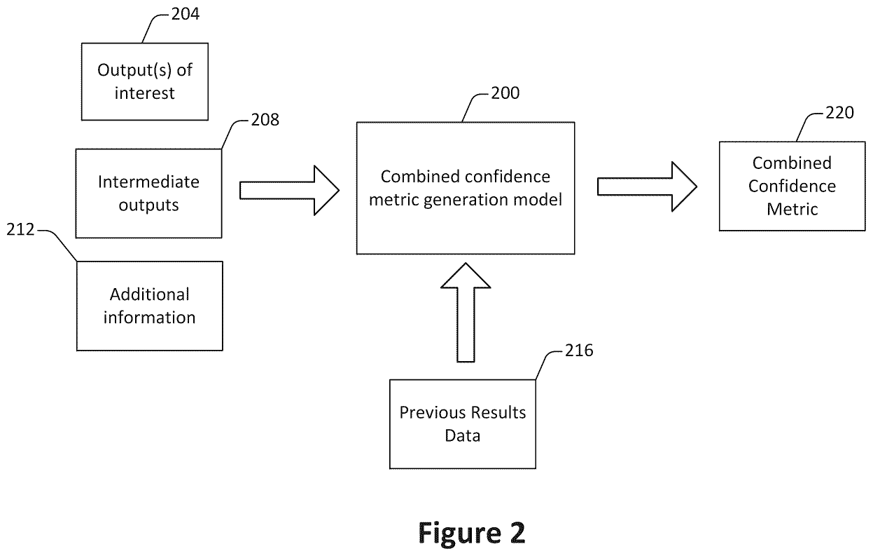

The way the combined confidence metric is determined may vary based on the use case. By way of example, FIG. 2 illustrates one example of a block diagram of a combined confidence metric generation model, in accordance with some implementations. Combined confidence metric generation model 200 of FIG. 2 takes the following inputs: final output of interest 204 (e.g., type of crop defect being analyzed, location of crop defect being analyzed, and/or severity of crop defects), intermediate outputs 208 (e.g., results of computer vision algorithms, 3D reconstructions, etc.), and additional information 212 of the given crop being analyzed (e.g., crop type/variety, recent rainfall information, an indication of whether any pests have been detected in the vicinity of the crops being analyzed, etc.)

The architecture of the combined confidence metric generation model (e.g., combined confidence metric generation model 200 of FIG. 2), may vary across implementations. For example, the combined confidence metric generation model may be a neural network, combination of neural networks, or other deep learning architecture.

When generating a combined confidence metric, “correctness criteria” (e.g., a definition of what is considered correct) may vary across implementations. By way of example, in some implementations, only the correctness of the location of the defect may be of interest. Alternatively, only the correctness of the type and severity of the defect may be of interest in other implementations. The following provide several nonlimiting examples of correctness criteria for defect detection use cases: “a defect prediction is considered correct if there exists any real defect in the same location of the predicted defect,” “a defect prediction is considered correct if there exists any real defect in the same location of the predicted defect and the predicted defect type is the same as the real defect type,” “a defect prediction is considered correct if the predicted defect type is the same as the real defect type,”etc.

Once inputs and correctness criteria are defined, the combined confidence metric generation model may generate a confidence metric. Such combined confidence metric generation may include several steps. By way of illustration, in the context of defect detection, combined confidence metric generation may include, among other steps, a fitting step, a predicting step, and post-processing.

A fitting step may be performed at least once for each combination of system and use case. The fitting step may involve the collection of a statistically representative set of samples of features and the corresponding expected value of the correctness criteria. The fitting step may begin with translating the inputs of the combined confidence metric generation model (e.g., final output, intermediate outputs, additional inputs, metadata associated with additional inputs, etc.) to a same domain. For example, categorical values cannot be meaningfully compared with numerical values. Therefore, these inputs may be pre-processed depending on the type of each input. By way of example, categorical values (e.g., crop type, defect location prediction, defect type prediction) may be pre-processed with a one-hot encoding, numerical inputs (e.g., crop age and size) may be pre-processed so each numerical input has a known mean and variance.

In some implementations, additional synthetic inputs may be added to improve the expressive power of the model. For example, the cross product of two categorical inputs may be added.

In some implementations, after the pre-processing step is performed, a statistical model may be created to find the best predictor of the correctness criteria. This predictor may be a logistic regressor, a random forest regressor, a gradient boosting machine, etc.

The combined confidence metric generation model may be trained by running the pipeline and verifying the results. By way of example. the pipeline may be run. The results of the pipeline may be verified as either correct or incorrect by an inspector. These verified correct or incorrect results may comprise previous result data 216 of FIG. 2. The confidence model 200 may be run to determine how the final output of interest 204, intermediate outputs 208, and additional information 212 contribute to the correctness of the results of the pipeline. Accordingly, the confidence model 200 may determine how the confidence metrics of each of the intermediate outputs 208, may be aggregated to generate a combined confidence metric 220 for the final output of the pipeline. By way of example, certain types of crops may be more prone to certain types of damage (e.g., certain fungi may only affect bananas), outdoor unirrigated crops in drought prone zones may be more likely to be damaged, etc. Therefore, combined confidence metrics may be based on data associated with a crop such as location of the crop, age of the crop, type of the crop, season during which the crop is being analyzed, etc. Some intermediate outputs (e.g., overlapping of images, quality of 3D reconstruction etc.) may vary in reliability. Some final output (which component of a crop contains a defect, the severity of a defect etc.) may be more or less accurate. Other priors such as lighting, time of day images are captured, camera type, etc. may affect the combined confidence metric of a final output.

One having skill in the art can appreciate that if any component of a pipeline is changed, the combined confidence metric generation model of the pipeline may be adjusted. In other words, the changed pipeline may be re-run and re-verified. The combined confidence metric generation mode may be re-trained based on the re-run and re-verified changed pipeline using the techniques described above.

In some implementations, after the fitting step is complete, the combined confidence metric generation model may be employed to predict combined confidence metrics for new test data. The inputs for this prediction may be the same type of inputs used during fitting, described above. When making a prediction, the combined confidence metric generation model may apply the parameters learned by the combined confidence metric generation model during fitting. Thus, when making predictions, the combined confidence metric generation model may pre-process inputs in the manner discussed above and predict the expected probability of this set of input features to be associated to a correct result using the fitted predictor.

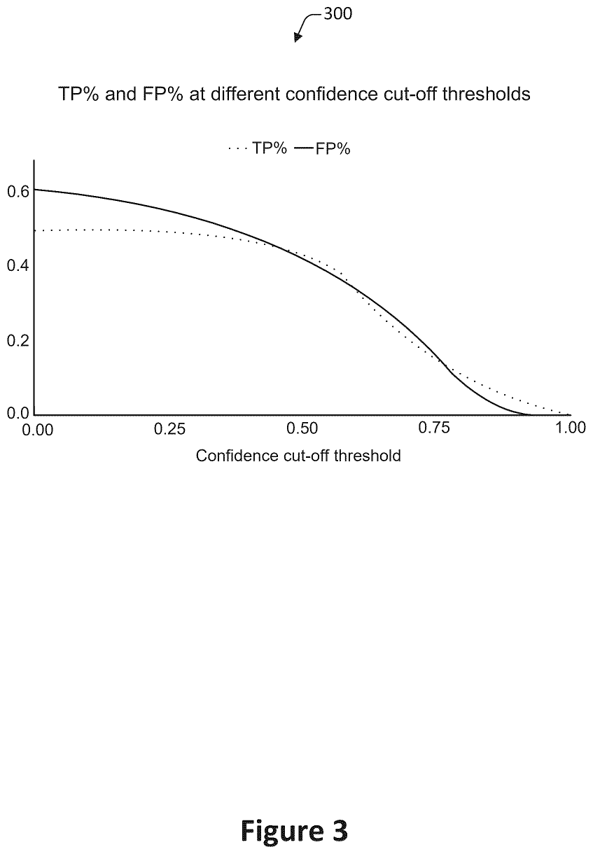

At 112, it is determined that one or more combined confidence metrics are below a threshold. As discussed above, the combined confidence metric of a system may be interpreted as a representation of the probability of an estimate or prediction of the system being correct. As such, defining a combined confidence metric threshold below which estimates or predictions may be discarded, allows users to control the expected number of false positives and true positives. By way of illustration, FIG. 3 illustrates an example of a graph 300 showing the variation in false positive rejection rates and true positive rejection rates versus confidence metric threshold, in accordance with some implementations. Graph 300 demonstrates the effect on the true positives and false positives of a given system when dropping predictions at different combined confidence metric thresholds. For the given example, by selecting a threshold of 0.35, the false positive rate drops from 60% to 50%, while the true positive rate will drop only from 50% to 48%, thus improving the overall accuracy of the system.

One having skill in the art may appreciate that increasing the threshold too much would start causing an increasing number of true positives to be discarded. As such, a combined confidence metric threshold may be selected based on particular objectives. For instance, a user may choose a threshold that optimizes accuracy of a full pipeline. In another example, a potential business objective may be improving time savings of inspection when locating areas of a crop that need increased irrigation.

In another example, in confronting an invasive pest epidemic, a professional inspector might expect a pest detection pipeline to report everything that has even the smallest probability of being associated with the invasive pest, even if that leads to a large number of false positives.

In yet another example, a non-professional user does not have the expertise to discard false positives. The non-professional user may want to have the defect detection pipeline report only defects with a high probability of being actual defects (true positives). Moreover, different use cases might have different definitions of what is considered a correctness criteria, as described above.

Returning to FIG. 1, at 116, outputs associated with each of the combined confidence metrics that are below the threshold are caused to be discarded. The outputs may be caused to be discarded in response to determining that the one or more combined confidence metrics are below the threshold.

Also or alternatively, outputs may be sorted by combined confidence metric. By way of example, in the defect detection context, a list of defects may be presented to a user via a user interface. The list may be sorted by combined confidence metric with defects having higher combined confidence metrics being displayed higher on the list than the defects with lower combined confidence metrics.

In some implementations, the confidence metric threshold may be dynamically adjustable. By way of example, a user may be to change the threshold and see heatmaps showing defects and severity or list of defects that meet the threshold chosen by the user so defects may appear, disappear, and reappear from the list or heatmap as the user varies the threshold.

In some implementations, at 120 of FIG. 1, the disclosed techniques may be used to correct discarded output(s). For example, there may be an output with a low confidence metric. The model may attempt to change the prediction and see if the confidence metric is higher. By way of illustration, the model predicts that a section of a wheat crop contains drought-related defects. The confidence metric for this prediction is below the threshold. Therefore, this prediction is discarded. The model may then change the prediction to the second-best guess of a smaller section of the wheat crop containing the defect. The confidence metric for the prediction that the smaller section of the wheat crop containing the defect is higher than the threshold. Therefore, the prediction may be changed to smaller section of the wheat crop containing the defect and this prediction may be presented to users.

In some implementations, confidence metrics may be used to improve the quality of a pipeline. By way of example, the confidence model 200 of FIG. 2 gives an extremely high importance of the 3-D reconstruction quality. Therefore, in this example, the 3-D reconstruction part of the pipeline is critical and improving this area may significantly improve the pipeline.

One having skill in the art may appreciate that the combined confidence metric generation method is independent of the system used to solve any problem. As such, the disclosed techniques may be applied to any pipeline that consists of multiple steps (e.g., pipelines for object detection and tracking or for object detection and classification) and may exploit any available metadata in addition to the information of the pipeline itself.

One having skill in the art can appreciate that some of the agricultural applications of the disclosed techniques may be practiced in a variety of contexts such as outdoor conventional or organic farms, greenhouses growing conventional or organic crops, etc. For instance vertical farming and indoor agriculture optimization may benefit from enhanced image and defect detection. By continuously monitoring plant growth, health, and development within controlled environments, these advanced systems may provide real-time guidance on optimizing lighting, temperature, humidity, and nutrient delivery to maximize yields while minimizing resource consumption. By way of example, a greenhouse system may be implemented using a computing system, a camera system, and a variety of other systems such as sensors (e.g., temperature sensors, soil sensors, water sensors, etc.), an automated irrigation system, etc.

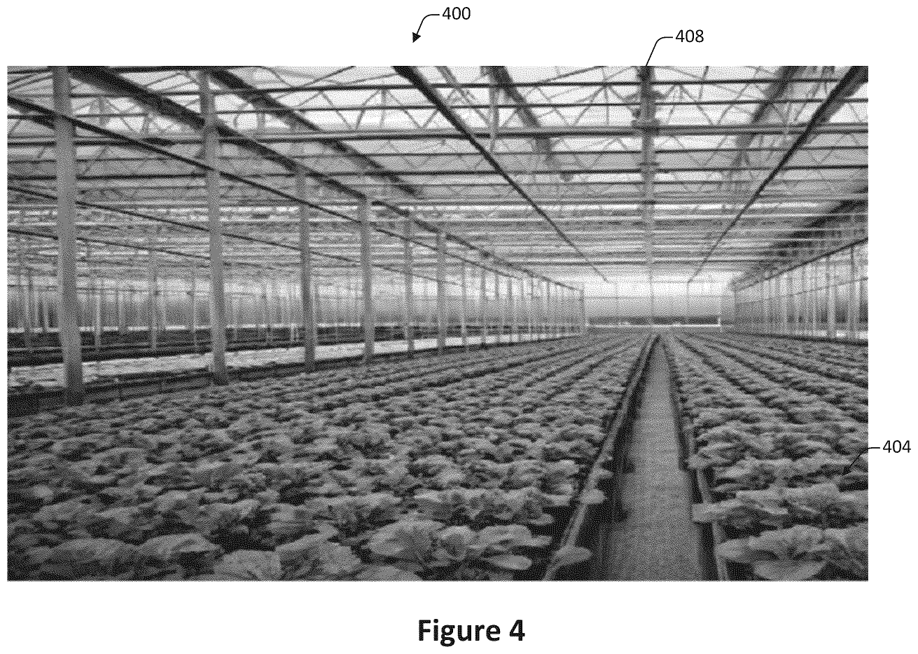

In one example of such a greenhouse system, FIG. 4 depicts an interior of a greenhouse system 400 growing lettuce 404. In conjunction with the computing system, the greenhouse system may be configured to work in conjunction with a computing system such as those described herein to cause a variety of methods such as method 100 of FIG. 1 to be performed.

In some implementations, intermediate outputs may be generated using images captured by a camera system and or information associated with sensors of a greenhouse system. By way of example, the greenhouse system 400 may include camera array 408, which capture images of the lettuce 404. The images of the lettuce 404 may be processed using a complex pipeline to identify defects associated with the lettuce 404.

As discussed above, the combined confidence metric generation techniques discussed herein may be applied in any complex pipeline such as those related to advanced image analysis and defect detection. Below, several non-limiting examples of such complex pipelines in the agricultural field and their potential benefits are discussed.

In some implementations, the advanced image and defect detection capabilities discussed herein may be applied in crop scouting and health monitoring. Enhanced algorithms may more accurately identify early signs of diseases (e.g., fungal infections, bacterial spots), pests (e.g., insects, nematodes), or nutrient deficiencies from high-resolution drone or satellite images. This would enable farmers to take swift, targeted action, reducing the risk of widespread damage and minimizing the use of chemical treatments.

Also or alternatively, automated weed detection and management systems may apply complex pipelines using advanced image analysis. By accurately identifying weed species among crops, these enhanced systems may trigger precision spraying or autonomous weeding machines to eliminate unwanted growth, reducing herbicide overuse and preventing yield loss. Moreover, such technology may also be applied to detect the emergence of herbicide-resistant weed populations.

In some implementations, fruit and vegetable quality inspection lines may be optimized using advanced image analysis and defect detection. By way of illustration, enhanced computer vision may rapidly assess produce for subtle signs of damage, decay, or deformities, ensuring only high-quality products reach market shelves. This would help reduce food waste, improve customer satisfaction, and protect brand reputations.

Also or alternatively, seedling and nursery stock evaluation may leverage advanced image analysis to detect early signs of stress, disease, or genetic abnormalities in young plants. By identifying potential issues before they escalate, nurseries and greenhouses may take proactive measures to ensure healthier, more robust seedlings are transplanted to fields.

In some implementations, soil erosion and degradation assessment may benefit from enhanced image analysis, allowing for the detection of subtle changes in soil texture, moisture levels, or vegetation cover indicative of erosion or degradation. This would enable farmers to implement targeted conservation measures, preserving fertile land and preventing environmental damage.

Also or alternatively, underground root system analysis may utilize advanced image and defect detection to non-invasively assess the health, structure, and development of plant root systems. By analyzing images captured through ground-penetrating sensors or other imaging technologies, farmers might optimize soil conditions, nutrient delivery, and irrigation strategies to boost crop resilience and productivity.

In some implementations, pollinator health monitoring via image and defect detection may play a crucial role in safeguarding these vital ecosystem components. By analyzing images of bees, butterflies, or other pollinators captured near agricultural sites, AI-powered systems might identify early signs of stress, disease, or pesticide exposure, enabling targeted interventions to protect pollinator populations.

In some implementations, soil microbiome analysis through image recognition may improve understanding of soil health. By applying advanced image analysis to microscopic images of soil samples, researchers and farmers might rapidly identify beneficial or detrimental microbial communities, informing strategies to foster a balanced soil microbiome that enhances nutrient cycling, disease suppression, and overall ecosystem fertility.

Also or alternatively, autonomous detection of invasive species may leverage enhanced image and defect detection to identify early infestations of harmful invasive plants, animals, or insects. This would enable swift eradication efforts, preventing the disruption of native ecosystems and the significant economic losses that often accompany such invasions.

Also or alternatively, agricultural water quality monitoring through image analysis may provide an early warning system for detecting contaminants, algae blooms, or other water quality issues in irrigation sources. By analyzing images captured by underwater cameras or drones, AI-powered systems might identify subtle changes in water appearance, triggering prompt corrective actions to safeguard crop health and prevent environmental harm.

Also or alternatively, agricultural synthetic biology design and validation may be performed using enhanced image and defect detection to accelerate the design, testing, and validation of genetically engineered crops. By rapidly analyzing images of cellular structures, protein expressions, or other biomarkers, researchers might streamline the development of novel traits such as enhanced nutrition, drought tolerance, or disease resistance.

In some implementations, soil carbon sequestration monitoring through subsurface image analysis may play a crucial role in mitigating climate change. By applying advanced image analysis to subsurface scans captured by ground-penetrating radar, electrical resistivity tomography, or other innovative imaging modalities, researchers might accurately quantify soil carbon stocks, track changes over time, and identify optimal strategies for enhancing carbon sequestration in agricultural soils.

Also or alternatively, global agricultural ecosystem simulation and predictive analytics may leverage advanced image analysis of satellite images to inform large-scale, data-driven simulations of global food systems. By integrating satellite-derived insights on climate patterns, land use changes, and crop health with machine learning algorithms, researchers might predict and mitigate the effects of global events on food security.

One having skill in the art can appreciate that the combined confidence metric generation techniques described herein may be practiced in a variety of fields beyond the agricultural and automotive use cases described herein and are, therefore, not limited to these fields. By way of illustration, in a non-limiting example in the field of structural engineering, a complex structural assessment pipeline that includes advanced image analysis may be used for detection and/or identification structural defects in foundations of buildings. Confidence metrics of the intermediate outputs of the complex structural assessment pipeline may be combined using the techniques disclosed herein to generate combined confidence metrics for the final outputs (e.g., detection of structurally compromising defects in a foundation of a building) of the complex structural assessment pipeline.

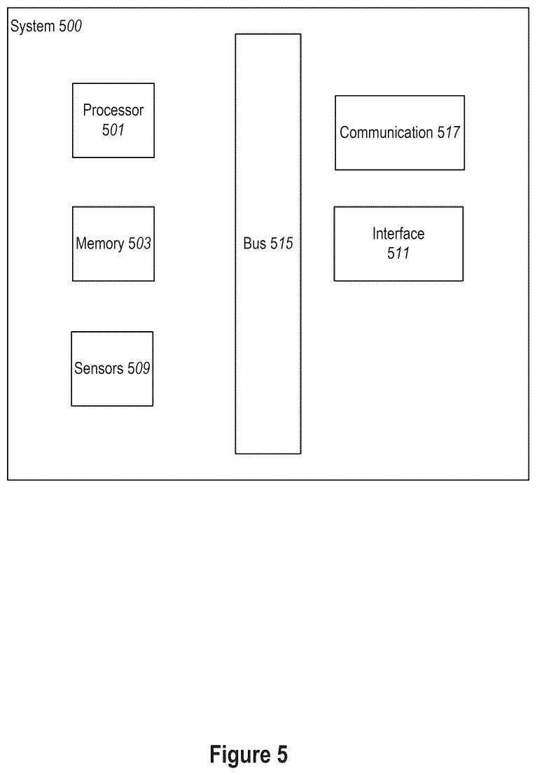

With reference to FIG. 5, shown is a particular example of a computer system that can be used to implement particular examples. For instance, the computer system 500 can be used to generate combined confidence metrics according to various embodiments described above. According to various embodiments, a system 500 suitable for implementing particular embodiments includes a processor 501, a memory 503, an interface 511, and a bus 515 (e.g., a PCI bus).

The system 500 can include one or more sensors 509, such as light sensors, accelerometers, gyroscopes, microphones, cameras including stereoscopic or structured light cameras. As described above, the accelerometers and gyroscopes may be incorporated in an IMU. The sensors can be used to detect movement of a device and determine a position of the device. Further, the sensors can be used to provide inputs into the system. For example, a microphone can be used to detect a sound or input a voice command.

In the instance of the sensors including one or more cameras, the camera system can be configured to output native video data as a live video feed. The live video feed can be augmented and then output to a display, such as a display on a mobile device. The native video can include a series of frames as a function of time. The frame rate is often described as frames per second (fps). Each video frame can be an array of pixels with color or gray scale values for each pixel. For example, a pixel array size can be 512 by 512 pixels with three color values (red, green, and blue) per pixel. The three-color values can be represented by varying amounts of bits, such as 24, 30, 36, 40 bits, etc. per pixel. When more bits are assigned to representing the RGB color values for each pixel, a larger number of colors values are possible. However, the data associated with each image also increases. The number of possible colors can be referred to as the color depth.

The video frames in the live video feed can be communicated to an image processing system that includes hardware and software components. The image processing system can include non-persistent memory, such as random-access memory (RAM) and video RAM (VRAM). In addition, processors, such as central processing units (CPUs) and graphical processing units (GPUs) for operating on video data and communication busses and interfaces for transporting video data can be provided. Further, hardware and/or software for performing transformations on the video data in a live video feed can be provided.

In particular embodiments, the video transformation components can include specialized hardware elements configured to perform functions necessary to generate a synthetic image derived from the native video data and then augmented with virtual data. In data encryption, specialized hardware elements can be used to perform a specific data transformation, i.e., data encryption associated with a specific algorithm. In a comparable manner, specialized hardware elements can be provided to perform all or a portion of a specific video data transformation. These video transformation components can be separate from the GPU(s), which are specialized hardware elements configured to perform graphical operations. All or a portion of the specific transformation on a video frame can also be performed using software executed by the CPU.

The processing system can be configured to receive a video frame with first RGB values at each pixel location and apply operation to determine second RGB values at each pixel location. The second RGB values can be associated with a transformed video frame which includes synthetic data. After the synthetic image is generated, the native video frame and/or the synthetic image can be sent to a persistent memory, such as a flash memory or a hard drive, for storage. In addition, the synthetic image and/or native video data can be sent to a frame buffer for output on a display or displays associated with an output interface. For example, the display can be the display on a mobile device or a view finder on a camera.

In general, the video transformations used to generate synthetic images can be applied to the native video data at its native resolution or at a different resolution. For example, the native video data can be a 512 by 512 array with RGB values represented by 24 bits and at frame rate of 24 fps. In some embodiments, the video transformation can involve operating on the video data in its native resolution and outputting the transformed video data at the native frame rate at its native resolution.

In other embodiments, to speed up the process, the video transformations may involve operating on video data and outputting transformed video data at resolutions, color depths and/or frame rates different than the native resolutions. For example, the native video data can be at a first video frame rate, such as 24 fps. But the video transformations can be performed on every other frame and synthetic images can be output at a frame rate of 12 fps. Alternatively, the transformed video data can be interpolated from the 12-fps rate to 24 fps rate by interpolating between two of the transformed video frames.

In another example, prior to performing the video transformations, the resolution of the native video data can be reduced. For example, when the native resolution is 512 by 512 pixels, it can be interpolated to a 256 by 256-pixel array using a technique such as pixel averaging and then the transformation can be applied to the 256 by 256 array. The transformed video data can output and/or stored at the lower 256 by 256 resolution. Alternatively, the transformed video data, such as with a 256 by 256 resolution, can be interpolated to a higher resolution, such as its native resolution of 512 by 512, prior to output to the display and/or storage. The coarsening of the native video data prior to applying the video transformation can be used alone or in conjunction with a coarser frame rate.

As mentioned above, the native video data can also have a color depth. The color depth can also be coarsened prior to applying the transformations to the video data. For example, the color depth might be reduced from 40 bits to 24 bits prior to applying the transformation.

As described above, native video data from a live video can be augmented with virtual data to create synthetic images and then output in real-time. In particular embodiments, real-time can be associated with a certain amount of latency, i.e., the time between when the native video data is captured and the time when the synthetic images including portions of the native video data and virtual data are output. In particular, the latency can be less than 100 milliseconds. In other embodiments, the latency can be less than 50 milliseconds. In other embodiments, the latency can be less than 30 milliseconds. In yet other embodiments, the latency can be less than 20 milliseconds. In yet other embodiments, the latency can be less than 10 milliseconds.

The interface 511 may include separate input and output interfaces or may be a unified interface supporting both operations. Examples of input and output interfaces can include displays, audio devices, cameras, touch screens, buttons, and microphones. When acting under the control of appropriate software or firmware, the processor 501 is responsible for such tasks such as optimization. Various specially configured devices can also be used in place of a processor 501 or in addition to processor 501, such as graphical processor units (GPUs). The complete implementation can also be done in custom hardware. The interface 511 is typically configured to send and receive data packets or data segments over a network via one or more communication interfaces, such as wireless or wired communication interfaces. Particular examples of interfaces the device supports include Ethernet interfaces, frame relay interfaces, cable interfaces, DSL interfaces, token ring interfaces, and the like.

In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to various embodiments, the system 500 uses memory 503 to store data and program instructions and maintained a local side cache. The program instructions may control the operation of an operating system and/or one or more applications, for example. The memory or memories may also be configured to store received metadata and batch requested metadata. The memory 503 may include one or more non-transitory computer readable media having instructions stored thereon for performing any of the methods disclosed herein such as the method 100 of FIG. 1. The system 500 of FIG. 5 can be integrated into a single device with a common housing. For example, system 500 can include a camera system, processing system, frame buffer, persistent memory, output interface, input interface and communication interface. In various embodiments, the single device can be a mobile device like a smart phone, an augmented reality and wearable device like Google Glass™ or a virtual reality head set that includes multiple cameras, like a Microsoft Hololens™. In other embodiments, the system 500 can be partially integrated. For example, the camera system can be a remote camera system. As another example, the display can be separate from the rest of the components like on a desktop PC. In some implementations, the system 500 of FIG. 5 may be distributed across devices such as server systems, database systems, camera systems, etc.

1. A method comprising:
maintaining a computing system configured to process a plurality of intermediate outputs from machine learning models to generate final outputs, the intermediate outputs having corresponding confidence metrics;
automatically determining, based on the intermediate outputs, a combined confidence metric that reflects a probability that the final outputs are accurate;
determining that one or more combined confidence metrics are below a threshold; and
causing, responsive to determining that the one or more combined confidence metrics are below the threshold, outputs associated with each of the combined confidence metrics that are below the threshold to be discarded.

2. The method of claim 1, further comprising:
correcting one or more of the outputs associated with the combined confidence metrics that are below the threshold; and
presenting the corrected outputs in a user interface of a display device.

3. The method of claim 1, wherein determining the combined confidence metric is further based on prior information.

4. The method of claim 3, wherein the prior information includes lighting associated with capture of images associated with the intermediate or final outputs, time of day of capture of the images, and/or a camera type associated with capture of the images.

5. The method of claim 1, wherein the threshold is dynamically adjustable by users of the computing system.

6. The method of claim 1, wherein the final outputs include predictions of plant diseases, pests, and/or nutrient deficiencies.

7. The method of claim 1, wherein the final outputs include detected defects associated with fruits or vegetables.

8. The method of claim 1, wherein the final outputs include assessment of soil erosion or degradation.

9. The method of claim 1, wherein the final outputs include identification of structural defects associated with a building.

10. A greenhouse system comprising: an indoor greenhouse, a computing system, and a camera system, the greenhouse system configured to cause:
processing, via the computing system, a plurality of intermediate outputs from machine learning models to generate final outputs, the intermediate outputs having corresponding confidence metrics;
automatically determining, based on the intermediate outputs, a combined confidence metric that reflects a probability that the final outputs are accurate;
determining that one or more combined confidence metrics are below a threshold; and
causing, responsive to determining that the one or more combined confidence metrics are below the threshold, outputs associated with each of the combined confidence metrics that are below the threshold to be discarded.

11. The greenhouse system of claim 10, further comprising sensors, wherein the intermediate outputs are generated using images captured by the camera system and or information associated with the sensors.

12. The greenhouse system of claim 10, the greenhouse system further configured to cause:
correcting one or more of the outputs associated with the combined confidence metrics that are below the threshold; and
presenting the corrected outputs in a user interface of a display device.

13. The greenhouse system of claim 10, wherein determining the combined confidence metric is further based on prior information.

14. The greenhouse system of claim 13, wherein the prior information includes lighting associated with capture of images associated with the intermediate or final outputs, time of day of capture of the images, and/or a camera type associated with capture of the images.

15. The greenhouse system of claim 10, wherein the threshold is dynamically adjustable by users of the computing system.

16. The greenhouse system of claim 10, wherein the final outputs include predictions of plant diseases, pests, and/or nutrient deficiencies.

17. The greenhouse system of claim 10, wherein the final outputs include detected defects associated with fruits or vegetables.

18. The greenhouse system of claim 10, wherein the final outputs include assessment of soil erosion or degradation.

19. One or more non-transitory computer readable media having instructions stored thereon for performing a method, the method comprising:
maintaining a computing system configured to process a plurality of intermediate outputs from machine learning models to generate final outputs, the intermediate outputs having corresponding confidence metrics;
automatically determining, based on the intermediate outputs, a combined confidence metric that reflects a probability that the final outputs are accurate;
determining that one or more combined confidence metrics are below a threshold; and
causing, responsive to determining that the one or more combined confidence metrics are below the threshold, outputs associated with each of the combined confidence metrics that are below the threshold to be discarded.

20. The one or more non-transitory computer readable media of claim 19, the method further comprising:
correcting one or more of the outputs associated with the combined confidence metrics that are below the threshold; and
presenting the corrected outputs in a user interface of a display device.
